(19) United States
(12) Patent Application Publication
(10) Pub. No.: US 2002/0152162 A1
(43) Pub. Date: Oct. 17, 2002

(54) Escrow trade agency system

(76) Inventors: Toshihiko Eda, Ibaraki-ken (JP); Takashi Kubokoya, Kanagawa-ken (JP); Tatsuya Setoguchi, Saitama-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/129,125

(22) PCT Filed: Dec. 12, 2000
(86) PCT No.: PCT/JP00/08769

(30) Foreign Application Priority Data
Sep. 14, 2000 (JP) 2000-280220

(51) Int. Cl. G06F 17/60

(52) U.S. Cl. 705/39

(57) ABSTRACT

An escrow transaction commission system 1 of the present invention is characterized by including escrow account specifying means 50 for allowing a buyer to specify an escrow account for depositing escrow money, money sending instructing means 51 for instructing a buyer specified financial institution 11 to send the escrow money to the escrow account, receipt verification transmitting means 52 for receiving verification of receipt of money from an escrow bank when the escrow cost is deposited in the escrow account, and then transmitting this receipt verification to a supplier, delivery verification receiving means 53 for receiving delivery verification of escrow target goods from the buyer when the supplier delivers the escrow target goods, and payment instruction transmitting means 54 for transmitting a payment instruction to the escrow bank to pay the escrow cost to a supplier specified financial institution 10 when the delivery verification is received.

### TECHNICAL FIELD

The present invention relates to an escrow transaction commission system for performing the commission of escrow transactions, which processes delivering goods and payment for costs generated by transactions on a portal site, and more particularly, to an escrow transaction commission system for enabling a buyer to specify an escrow bank from among a plurality of financial institutions.

### BACKGROUND ART

Presently, in business to business (B to B) transactions between companies, portal sites are present to deal in various goods including steel, foodstuffs, chemicals and the like, and sales transactions of goods are carried through the portal sites.

However, in such Internet transactions, where an order came from a buyer with no previous transactions, a supplier was unable to deliver goods because of the unknown credibility of the buyer.

On the other hand, when the buyer sent an order to a supplier with no previous transactions, the buyer was unable to transfer a payment for the order because of the unknown credibility of the supplier.

In order to solve the above-described problems, escrow transactions have conventionally been carried out as follows.

In an escrow transaction, first, an escrow company specifies a specific escrow account of a specified bank to the buyer. Then, when the buyer deposits money in the escrow account, the escrow company verifies the deposit of money, and reports the deposit of money to the supplier. Upon receipt of the report, the supplier delivers goods. Upon receipt of the goods, the buyer reports the receipt to the escrow agency. Upon receipt of the report notification, the escrow agency transfers the money deposited in the escrow account to the supplier, thus completing the escrow transaction.

However, in conventional escrow transactions, the buyer was unable to specify an escrow bank. Therefore, there has been a problem in that the buyer has to deposit money in an escrow bank with no previous transactions.

The present invention has been made in the light of the above-described problems, and it is an object of the present invention to provide an escrow transaction commission system capable of performing the commission of escrow transactions for an escrow bank preferred by a buyer, by enabling the buyer to specify the escrow bank from among a number of financial institutions.

### DISCLOSURE OF THE INVENTION

In order to achieve the foregoing object, an escrow transaction commission method of the present invention defined in claim 1 is a method in which transactions are carried out between a supplier for supplying goods and a buyer for buying the goods through a portal site using a computer system, and an escrow transaction commission for processing the transfer of goods and payment of costs generated by the transaction is executed by a server. This escrow transaction commission method is characterized in that the buyer specifies an escrow account for depositing escrow costs generated by the transaction on the portal site, the server allows a buyer-specified financial institution specified by the buyer to send the escrow costs to an escrow bank holding the escrow account when the buyer enters an instruction to send the escrow costs to the escrow account, and when deposit of the escrow costs in the escrow account is performed, the server receives a verification of receipt of money from the escrow bank and then transmits the verification of receipt of money to the supplier, and when the supplier, having received the verification of receipt of money delivers escrow target goods to the buyer, the server allows the escrow bank to pay the escrow costs deposited in the escrow account into a supplier-specified financial institution specified by the supplier.

According to the invention of claim 1, since the buyer can specify an escrow bank from among a number of financial institutions, it is possible to perform an escrow transaction commission with for the escrow bank desired by the buyer.

An escrow transaction commission apparatus of the present invention defined in claim 2 is an apparatus for carrying out transactions between a supplier for supplying goods and a buyer for buying the goods through a portal site using a computer system, and for executing an escrow transaction commission for processing the transfer of goods and payment of costs generated by the transaction by a server. This escrow transaction commission apparatus is characterized by including an escrow account specifying means for allowing the buyer to specify an escrow account for depositing the escrow costs generated by the transaction on the portal site, money sending instructing means for instructing a buyer-specified financial institution specified by the buyer to send the escrow costs to an escrow bank having the escrow account when the buyer enters an instruction to send money to the escrow account specified by the escrow account specifying means; a verification of receipt transmitting means for receiving a verification of receipt of money from the escrow bank when the escrow costs instructed to be sent by the money sending instructing means are deposited in the escrow account, and then transmitting this verification of receipt of money to the supplier; a delivery-verification receiving means for receiving a delivery-verification for verifying delivery of escrow target goods from the buyer when the supplier delivers the escrow target goods to the buyer based on the verification of receipt of money transmitted from the verification of receipt transmitting means; and a payment-instruction transmitting means for transmitting a payment-instruction to the escrow bank to pay the escrow costs deposited in the escrow account to a supplier-specified financial institution specified by the supplier when the delivery-verification is received by the delivery-verification receiving means.

According to the invention of claim 2, since the buyer can specify an escrow bank from among a number of financial institutions, it is possible to perform an escrow transaction commission with the escrow bank desired by the buyer.

A recording-medium for recording an escrow transaction commission program in an escrow transaction commission apparatus of the present invention defined in claim 3 is a recording-medium for recording an escrow transaction commission program for carrying out transactions between a supplier for supplying goods and a buyer for buying the goods through a portal site using a computer system, and for executing an escrow transaction commission for processing the transfer of goods and payment of costs generated by the transaction on the portal site. This recording medium is characterized by including an escrow account specification process for allowing the buyer to specify an escrow account for depositing escrow costs generated by the transaction, money-sending instructions for instructing a buyer-specified financial institution specified by the buyer to send the escrow costs to an escrow bank having the escrow account when the buyer enters an instruction to send money to the escrow account specified by the escrow account specification; a verification of receipt transmission process for receiving a verification of receipt of money from the escrow bank when the escrow costs instructed to be sent by the money-sending instruction is deposited in the escrow account, and then transmitting this verification of receipt to the supplier; a delivery-verification reception process for receiving delivery-verification for verifying the delivery of escrow target goods from the buyer when the supplier delivers the escrow target goods to the buyer based on the verification of receipt transmitted from the verification of receipt transmission process; and a payment-instruction transmission process for transmitting a payment-instruction to the escrow bank to pay the escrow costs deposited in the escrow account to a supplier-specified financial institution specified by the supplier when delivery-verification is received by delivery-verification reception.

According to the invention of claim 3, since the buyer can specify an escrow bank from among a number of financial institutions, it is possible to perform an escrow transaction commission with the escrow bank desired by the buyer.

A buyer terminal of the present invention defined in claim 4 is a terminal of a buyer for buying goods by carrying out transactions with a supplier for supplying goods, and for executing an escrow transaction through a server using a computer system. This buyer terminal is characterized in that the buyer is prompted to specify an escrow account for depositing escrow costs generated by the transaction with the supplier, the specified escrow account is transmitted to the server, the buyer is prompted to enter an instruction for sending the escrow costs to the escrow account, the entered money sending instruction is transmitted to the server, the supplier delivers escrow target goods to the buyer and when the buyer enters a delivery-verification for verifying the delivery of the escrow target goods, this delivery-verification is transmitted to the server.

According to the invention of claim 4, since the buyer can specify an escrow bank from among a number of financial institutions, it is possible to make an escrow transaction request from the escrow bank desired by the buyer.

A supplier terminal of the present invention defined in claim 5 is a supplier terminal of supplier for carrying out transactions with a buyer to sell goods, and for executing an escrow transaction through a server using a computer system. This supplier terminal is characterized in that when escrow costs generated by the transaction with the buyer are received in an escrow account for depositing the escrow cost, a verification of receipt of money transmitted from an escrow bank holding the escrow account is received through the server and when the escrow costs are sent to a supplier-specified financial institution specified by the supplier, a notice of payment completion is received from the supplier-specified financial institution.

According to the invention of claim 5, since the supplier can carry out the escrow transactions through the server, it is possible to deliver goods without any anxiety.

A escrow transaction commission method of the present invention defined in claim 6 is a method in which transactions are carried out between a supplier for supplying goods and a buyer for buying the goods using a computer system via a server, and an escrow transaction commission for processing the transfer of goods and payment of costs generated is executed by the transactions of a server. This escrow transaction commission method is characterized in that the buyer specifies an escrow account for depositing the escrow costs generated by the transaction between the buyer and the supplier, the server allows a buyer-specified financial institution specified by the buyer to send the escrow costs to the escrow account when the buyer enters an instruction for sending the escrow costs to the escrow account, when deposit of the escrow costs is performed in the escrow account, the server receives a verification of receipt of money from an escrow firm specified financial institution holding the escrow account and then transmits the verification of receipt of money to the supplier and when the supplier, having received the verification of receipt of money, delivers escrow target goods to the buyer, the server allows the escrow firm specified financial institution to pay the escrow costs to a supplier-specified financial institution specified by the supplier.

According to the invention of claim 6, since the buyer can specify an escrow firm from among a number of financial institutions, it is possible to perform an escrow transaction commission with the escrow firm desired by the buyer.

An escrow transaction commission apparatus of the present invention defined in claim 7 is an apparatus for carrying out transactions between a supplier for supplying goods and a buyer for buying the goods, and for executing an escrow transaction commission with processing the transfer of goods and payment of cost generated by the transaction using a computer. This escrow transaction commission apparatus is characterized by including an escrow account specifying means for allowing the buyer to specify an escrow account for depositing the escrow costs generated by the transaction between the buyer and the supplier; a money sending instructing means for instructing a buyer-specified financial institution specified by the buyer to send the escrow costs to the escrow account when the buyer enters an instruction to send money to the escrow account specified by the escrow account specifying means; a verification of receipt transmitting means for receiving a verification of receipt of money from an escrow firm specified financial institution holding the escrow bank account when the escrow costs instructed to be sent by the money sending instructing means are deposited in the escrow account, and then transmitting this verification of receipt to the supplier; a delivery-verification receiving means for receiving a delivery-verification for verifying the delivery of escrow target goods from the buyer when the supplier delivers the escrow target goods to the buyer based on the verification of receipt of money transmitted by the verification of receipt transmitting means; and a payment-instruction transmitting means for transmitting a payment-instruction to the escrow firm specified financial institution to pay the escrow costs deposited in the escrow account to a supplier-specified financial institution specified by the supplier when the delivery-verification is received by the delivery-verification receiving means.

According to the invention of claim 7, since the buyer can specify an escrow firm from among a number of financial institutions, it is possible to perform an escrow transaction commission with the escrow firm desired by the buyer.

The escrow account specifying means of the escrow transaction commission apparatus of the invention defined in claim 8 is characterized in that when the escrow cost exceeds an upper limit of deposits of the escrow firm for carrying out escrow business using an escrow account, the escrow costs are deposited in a plurality of escrow forms.

According to the invention of claim 8, it is thus possible to process escrow transactions which have been unable to be processed because a limit amount has been exceeded with a single escrow firm.

The escrow account specifying means in the escrow transaction commission apparatus of the invention defined in claim 9 is characterized in that when the escrow costs exceeds an upper limit of deposits of the escrow firm for carrying out escrow business using an escrow account, the deposit transfer of the escrow costs are made to an escrow firm having an upper limit of deposits equal to or higher than the escrow costs.

According to the invention of claim 9, it thus is possible to process escrow transactions that have been unable to be processed because a limit amount has been exceeded with a single escrow firm.

The escrow transaction commission apparatus of the invention defined in claim 10 is characterized by further including a distribution-state supplying means for receiving distribution-state information regarding a distribution-state from a distribution company for distributing the escrow target goods, and supplying the distribution state information to the buyer and the supplier.

According to the invention of claim 10, the buyer and the supplier can verify the distribution state of goods by accessing the escrow transaction commission apparatus.

A recording-medium for recording an escrow transaction commission program of the present invention defined in claim 11 is a recording-medium for recording an escrow transaction commission program for carrying out transactions between a supplier for supplying goods and a buyer for buying the goods, and for executing an escrow transaction commission for processing the transfer of goods and payment of costs generated by the transaction using a computer system. This recording-medium is characterized by including escrow account specification process for allowing the buyer to specify an escrow account for depositing escrow costs generated by the transaction between the buyer and the supplier, money-sending instructions for instructing a buyer-specified financial institution specified by the buyer to send the escrow costs to the escrow account when the buyer enters an instruction to send money to the escrow account specified by the escrow account specification; a verification of receipt transmission process for receiving a verification of receipt of money from an escrow firm specified financial institution holding the escrow account when the escrow costs instructed to be sent by the money sending instruction are deposited in the escrow account, and then transmitting this verification of receipt of money to the supplier; delivery-verification reception process for receiving delivery-verification for verifying the delivery of escrow target goods from the buyer when the supplier delivers the escrow target goods to the buyer based on the verification of receipt of money transmitted by the verification of receipt transmission process; and a payment-instruction transmission process for transmitting a payment-instruction to the escrow firm specified financial institution to pay the escrow costs deposited in the escrow account to a supplier-specified financial institution specified by the supplier when delivery-verification is received by delivery-verification reception.

According to the invention of claim 11, since the buyer can specify an escrow firm from among a number of financial institutions, it is possible to perform an escrow transaction commission with the escrow firm desired by the buyer.

A buyer terminal of the present invention defined in claim 12 is a buyer terminal of a buyer for carrying out transactions with a supplier for supplying goods to buy goods, and for executing an escrow transaction through a server using a computer system. This buyer terminal is characterized in that the buyer is prompted to specify an escrow account for depositing escrow costs generated by the transaction with the supplier, the specified escrow account is transmitted to the server, the buyer is prompted to enter an instruction for sending the escrow costs to the escrow account, the entered money sending instruction is transmitted to the server, the escrow cost is deposited in the escrow account, a notice of receipt of the escrow account is received through the server, a notice of acceptance is transmitted to the server when the buyer accepts the notice of the receipt of money, the supplier delivers escrow target goods to the buyer and when the buyer verifies preset acceptance inspection conditions for the escrow target goods, and enters delivery-verification, this delivery-verification is transmitted to the server.

According to the invention of claim 12, since the buyer can specify an escrow firm from among a number of financial institutions, it is possible to perform an escrow transaction commission with the escrow firm desired by the buyer.

A supplier terminal of a supplier of the present invention defined in claim 13 is a supplier terminal for carrying out transactions with a buyer to sell goods, and for executing an escrow transaction through a server using a computer system. This supplier terminal is characterized in that when escrow costs generated by the transaction with the buyer are received in an escrow account for depositing the escrow cost, a receipt notice transmitted from an escrow firm specified financial institution holding the escrow account is received through the server, a shipping instruction of escrow target goods is transmitted to a distribution company for distributing the escrow target goods when the supplier enters acceptance of the receipt notice and when the escrow costs are sent to a supplier-specified financial institution specified by the supplier, a notice of payment completion is received from the supplier-specified financial institution.

According to the invention of claim 13, since the supplier can carry out escrow transactions through the server, it is possible to deliver goods without any anxiety.

### BRIEF DESCRIPTION OF THE DRAWINGS

FIG. 1 is a block diagram showing a configuration of an escrow transaction commission system according to a first embodiment of the present invention.

FIG. 2 is a flowchart illustrating member information registration in the escrow transaction commission system shown in FIG. 1.

FIG. 3 is a view showing an example of a registration screen of a financial institution in the member information registration shown in FIG. 2.

FIG. 4 is a view showing an example of a display screen of member information in the member information registration process shown in FIG. 2.

FIG. 5 is a flowchart illustrating an escrow transaction commission carried out in the escrow transaction commission system shown in FIG. 1.

FIG. 6 is a view showing an example of a selection screen of a transaction method in the escrow transaction on commission system shown in FIG. 5.

FIG. 7 is a view showing an example of a verification screen of ordered goods in the process of escrow transaction commission shown in FIG. 5.

FIG. 8 is a view showing an example of a selection screen of an escrow bank in the escrow transaction commission system shown in FIG. 5.

FIG. 9 is a view showing an example of a specification screen of an escrow account in the escrow transaction commission system shown in FIG. 5.

FIG. 10 is a view showing an example of a log-in screen in the escrow transaction commission system shown in FIG. 5.

FIG. 11 is a view showing an example of a verification screen of money deposited to an escrow account in the escrow transaction commission system shown in FIG. 5.

FIG. 12 is a view showing an order specification of the verification screen of money deposited to the escrow account shown in FIG. 11.

FIG. 13 is a view showing an example of a verification screen of payment to the escrow account in the process of escrow transaction commission shown in FIG. 6.

FIG. 14 is a block diagram showing a configuration of an escrow transaction commission system according to a second embodiment of the present invention.

FIG. 15 is a flowchart illustrating registration process of escrow transaction in the escrow transaction commission system shown in FIG. 14.

FIG. 16 is a view showing an example of a selection screen of an escrow firm in the registration of the escrow transaction shown in FIG. 15.

FIG. 17 is a flowchart illustrating registration process of escrow transaction in the escrow transaction commission system shown in FIG. 14.

FIG. 18 is a flowchart illustrating a process when a plurality of escrow firms receives deposits in cooperation.

FIG. 19 is a flowchart illustrating a process when deposited money is transferred from a small escrow firm to a large escrow firm.

FIG. 20 is a flowchart illustrating escrow transaction commission in the escrow transaction commission system shown in FIG. 14.

FIG. 21 is a view showing an example of a total slip of transfer requests in the escrow transaction commission shown in FIG. 20.

FIG. 22 is a flowchart illustrating a process of escrow transaction commission when a request of refund is entered in the escrow transaction commission shown in FIG. 20.

### BEST MODES FOR CARRYING-OUT THE INVENTION

Next, description will be made of an escrow transaction commission system according to an embodiment of the present invention with reference to the accompanying drawings.

(First Embodiment)

1. System Configuration

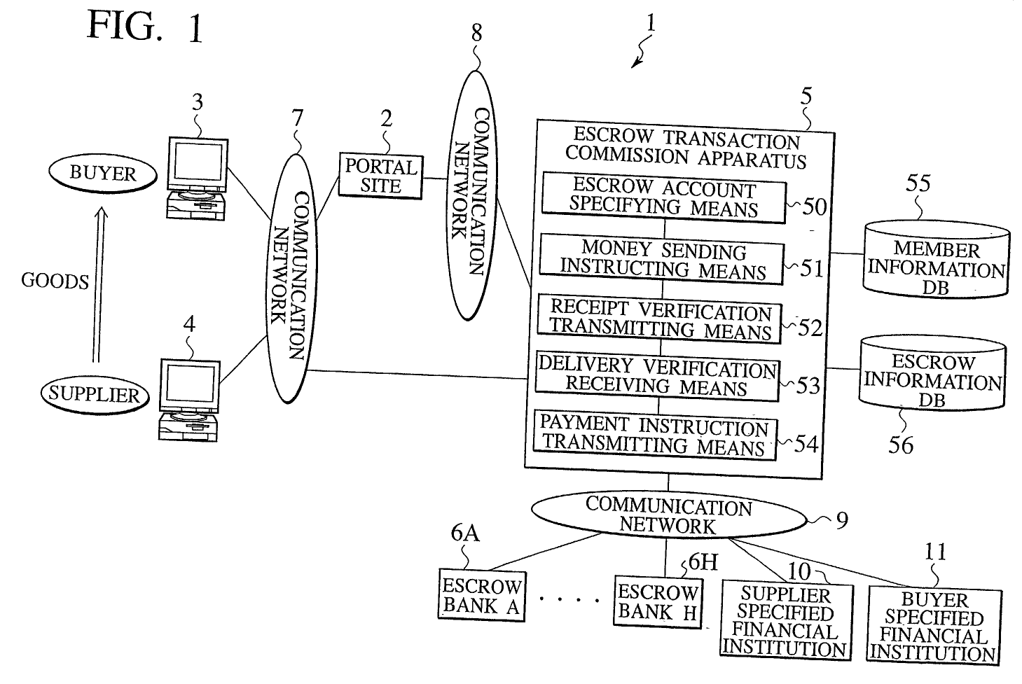

As shown in FIG. 1, an escrow transaction commission system 1 of the present embodiment includes a buyer terminal 3 of a buyer company for buying goods by accessing a portal site 2, a supplier terminal 4 of a supplier company for supplying goods information to the portal site 2, an escrow transaction commission apparatus 5 functioning as a server to execute escrow transactions commission for the transfer of goods and payment for charges generated by transactions between the supplier and the buyer, escrow banks 6A, 6B, . . . , and 6H having escrow accounts for deposing escrow costs, a supplier-specified financial institution 10 specified beforehand by the supplier, and a buyer-specified financial institution 11 specified beforehand by the buyer.

In this case, the buyer terminal 3, the supplier terminal 4, the portal site 2, and the escrow transaction commission apparatus 5 are interconnected by a communication network 7. The portal site 2, and the escrow transaction commission apparatus 5 are interconnected by a communication network 8. The escrow transaction commission apparatus 5 and the financial institutions 6A, . . . , 6H, 10 and 11 are interconnected by a communication network 9. The communication networks 7, 8 and 9 are composed of communication lines such as Internet, dial-up, a common carrier leased line, VPN, and a wireless connection. Especially, the communication network 8 is connected based on protocol of TCP/IP or SAP R3, and the communication network 9 is connected through Zengin protocol (Standard Communication Protocol of Japanese Bankers Association), or a SWIFT format in overseas remittance.

Further, the escrow transaction commission apparatus 5 includes escrow account specifying means 50 for allowing the buyer to specify an escrow account for depositing escrow costs generated by a transaction with the portal site 2, money-sending instructing means 51 for instructing the buyer-specified financial institution 11 to send the escrow costs to an escrow bank holdng the escrow account when the buyer enters an instruction to send money to the escrow account; a verification of receipt transmitting means 52 for receiving a verification of receipt of money from the escrow bank when the escrow costs are instructed to sent by the money sending instructing means 51, and transmitting this verification of receipt to the supplier; a delivery-verification receiving means 53 for receiving delivery-verification for verifying the delivery of escrow target goods from the buyer when the supplier delivers the escrow target goods to the buyer based on the verification of receipt, and a payment-instruction transmitting means 54 for transmitting a payment-instruction to the escrow bank to pay the escrow costs deposited in the escrow account to the supplier-specified financial institution 10.

Note that, the escrow transaction commission apparatus 5 is a server composed of a normal computer system including a CPU for executing various processing operations, and storing means for storing commands of the operations, managed by a so-called Internet provider, and connected through the Internet to a not-shown host computer. When access is made from the buyer terminal 3 or the supplier terminal 4 through the communication network 7 or 8, the escrow transaction commission apparatus 5 provides a home page directed to the buyer or the supplier. On this home page, information regarding the selection of an escrow account, verification of money deposited in the escrow account, an order specification and the like are displayed.

In addition, the escrow transaction commission apparatus 5 includes a member information database 55 for storing member information about a buyer or a supplier who becomes a member of the escrow transaction commission system 1, and an escrow information database 56 for storing escrow information which is necessary for escrow transactions.

The member information database 55 stores information such as a company name, a business establishment name, a division name in charge, a zip code, an address, a name of a person in charge, a telephone number, a FAX number, a specified financial institution name, a type of business, a portal ID, a portal member ID, a contract ID, and a user ID, the information being stored depending on the buyer information and supplier information.

Moreover, the escrow information database 56 stores information such as an escrow number, a buyer's name, a contract ID and a user ID of a buyer, a supplier's name, a contract ID and a user ID of a supplier, a name of goods, a part of goods, a quantity of goods, a unit price, a name of a specified financial institution name, an escrow bank name, a due date for payment, and acceptance inspection conditions, the information being stored depending on the escrow transactions.

Each of the escrow banks 6A, 6B, . . . and 6H have an escrow account for depositing escrow costs. When the escrow costs are sent from the buyer-specified financial institution 11 and deposited, and when the supplier has delivered escrow target goods to the buyer, the escrow bank pays the escrow costs to the supplier-specified financial institution 10.

2. Operation Explanation

Next, description will be made of all processing carried out by the escrow transaction commission system 1 of the present embodiment with reference to the accompanying drawings.

2-1. Member Information Registration Process

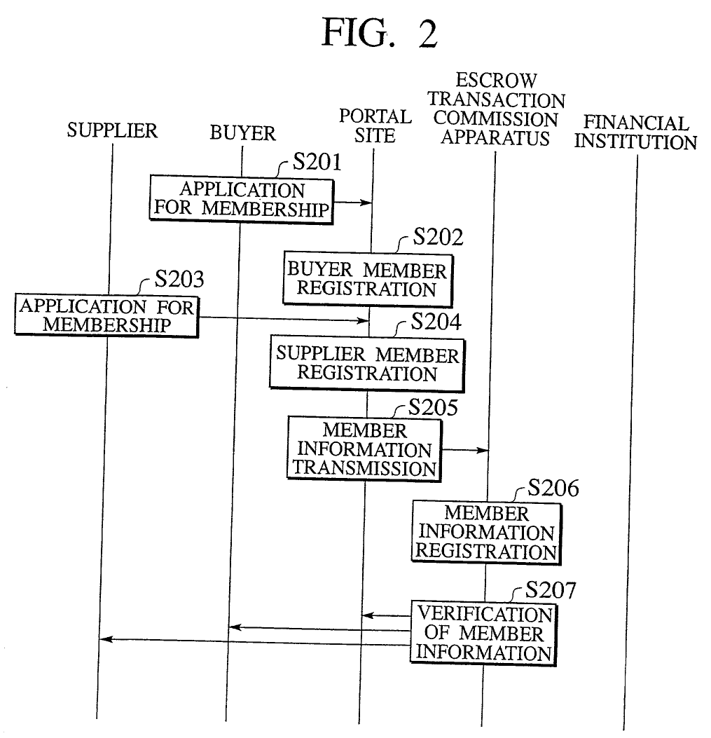

First, description is made of member information registration process of a buyer and a supplier by the escrow transaction commission system 1 of the embodiment based on a flowchart of FIG. 2.

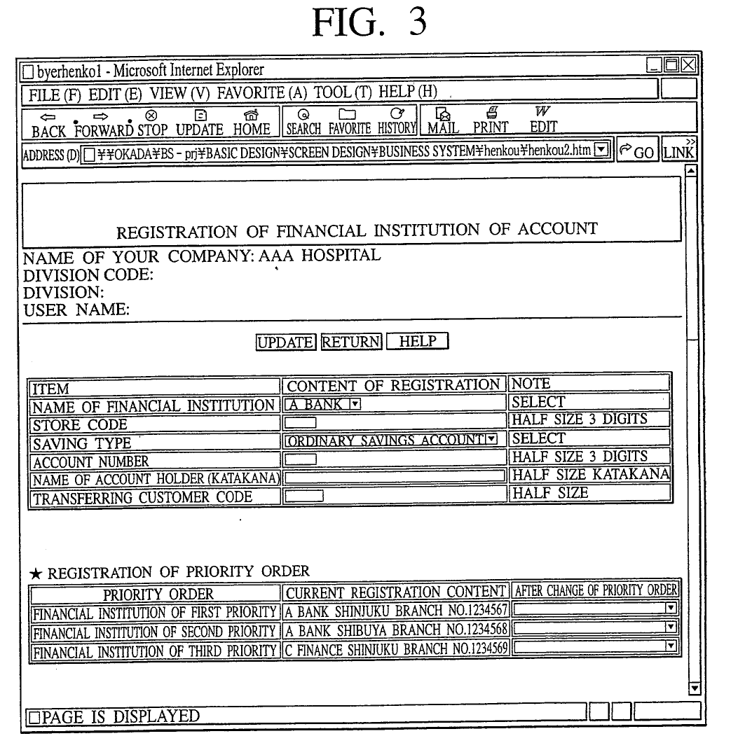

A buyer trying to make an escrow transaction commission using the escrow transaction commission system 1 of the embodiment applies for membership by accessing the portal site 2 for transactions from the buyer terminal 3 (S201). In this case, the buyer enters member information such as a company name, a business establishment name, and a name of a specified financial institution. Especially, the entry of the specified financial institution is performed on an input screen as that shown in FIG. 3. A plurality of buyer-specified financial institutions can be specified, and an order of priority can be also specified.

After the entry of member information, the portal site 2 provides a portal member ID, and carries out buyer member registration (S202).

Similarly, a supplier applies for membership by accessing the portal site 2 from the supplier terminal 4 (S203), and enters member information such as a company name, a business establishment, and supplier-specified financial institution name. Based on the member information, the portal site 2 provides a portal member ID, and carries out supplier member registration (S204).

Member registration is thus performed, then the portal site 2 adds the portal ID for specifying a portal site to the member information, and transmits it to the escrow transaction commission apparatus 5 (S205).

Then, upon having received the member information, the portal ID and the portal member ID, the escrow transaction commission apparatus 5 provides the contract ID and the user ID as a member ID of the escrow transaction commission apparatus 5 and registers the member ID (S206), and then stores the member information in the member information database 55.

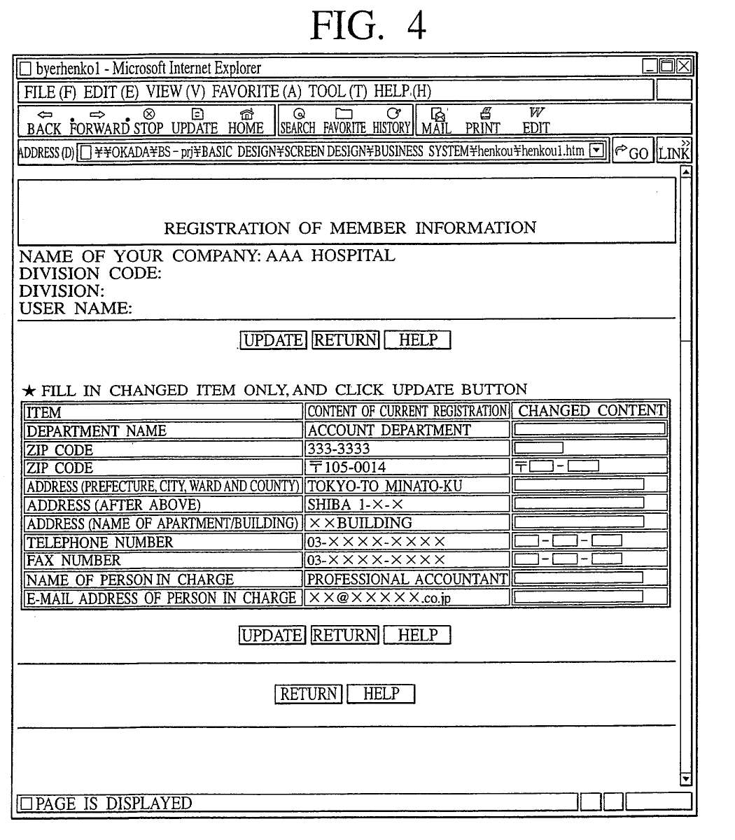

After the member information has been registered, a registration verification screen as that shown in FIG. 4 is presented to each of the supplier 4, the buyer 3 and the portal site 2, and the member information is verified (S207), thus completing the registration.

The specified financial institution and the member information can be changed from the screens of FIGS. 3 and 4 respectively.

2-2. Escrow Transaction on Commission Process

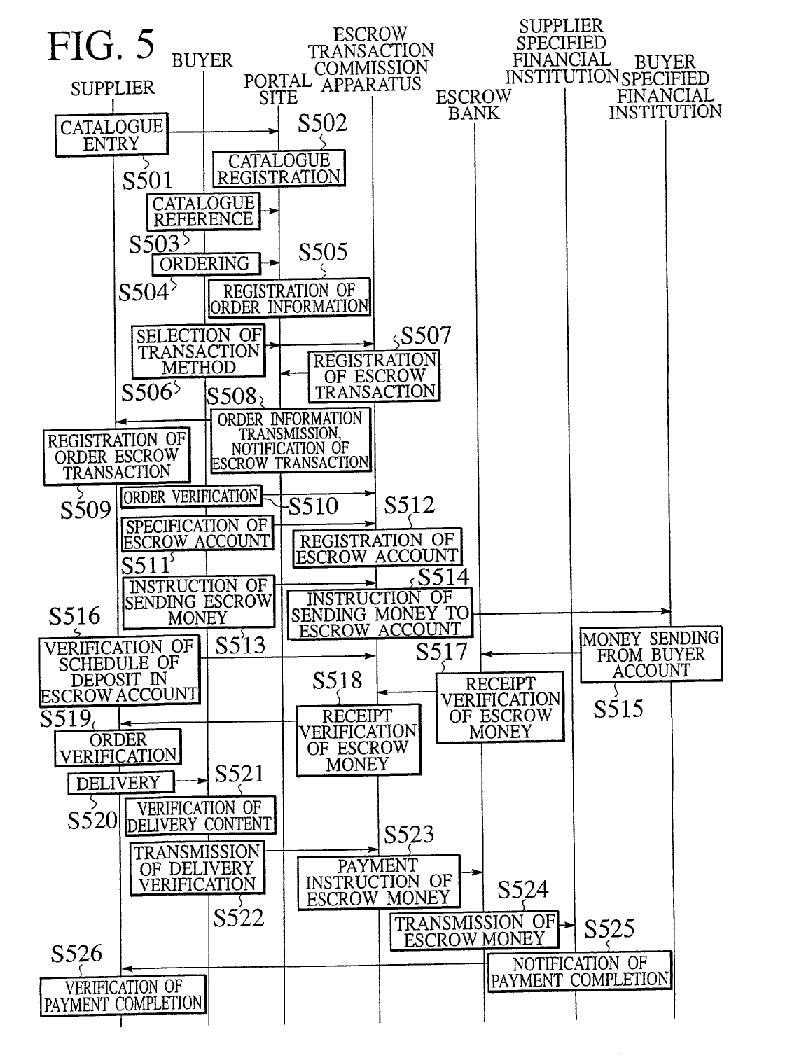

Next, description will be made of the process of escrow transactions commission using the escrow transaction commission apparatus 5 based on a flowchart of FIG. 5.

First, the supplier accesses the portal site 2 from the supplier terminal 4, and inscribes goods to be sold in a catalogue of the portal site 2 (S501). Upon receipt of this, the portal site 2 registers the goods in the catalogue (S502).

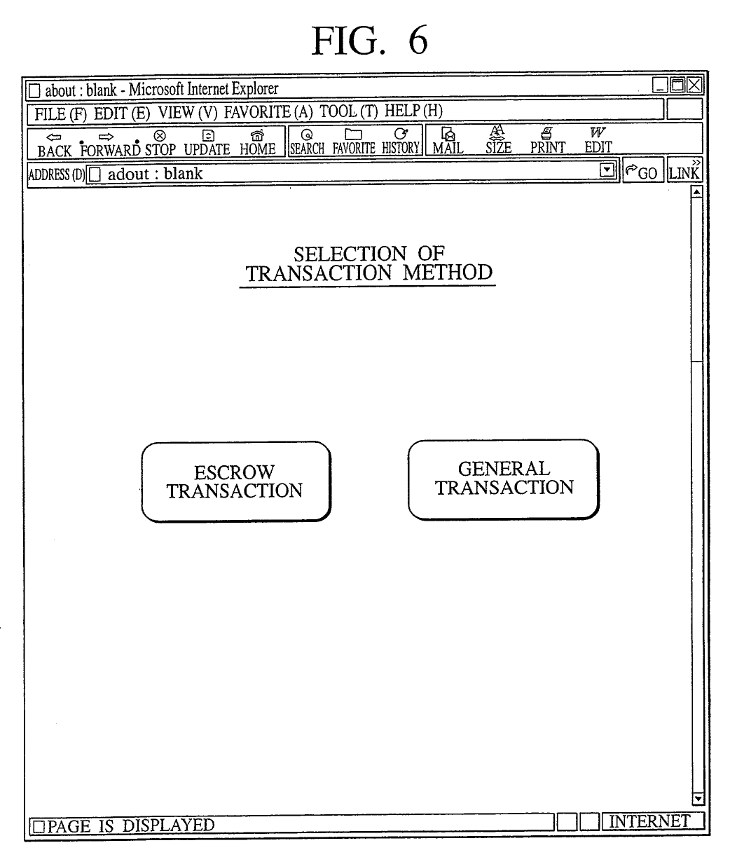

Then, the buyer accesses the portal site 2 from the buyer terminal 3, and refers to the catalogue (S503). When there are goods the buyer want to buy, the buyer sends an order to the portal site 2 (S504). Upon receipt of the order, the portal site 2 receives and registers the order information thereof (S505). In this case, the portal site 2 displays a selection screen as shown in FIG. 6, which allows the buyer to select an escrow transaction or a general transaction. When the buyer selects the escrow transaction, information thereof is transmitted to the portal site 2, and at the same time, transferred to the escrow transaction commission apparatus 5 (S506).

Upon having received the selection of the escrow transaction, the escrow transaction commission apparatus 5 adds the escrow number and registers the escrow transaction, and then returns registration information to the portal site (S507).

Then, the portal site 2 transmits the order information entered by the buyer and a notice of the execution of the escrow transaction to the supplier terminal of the supplier (S508). The supplier terminal receives an order based on the order information, and then registers the escrow transaction (S509).

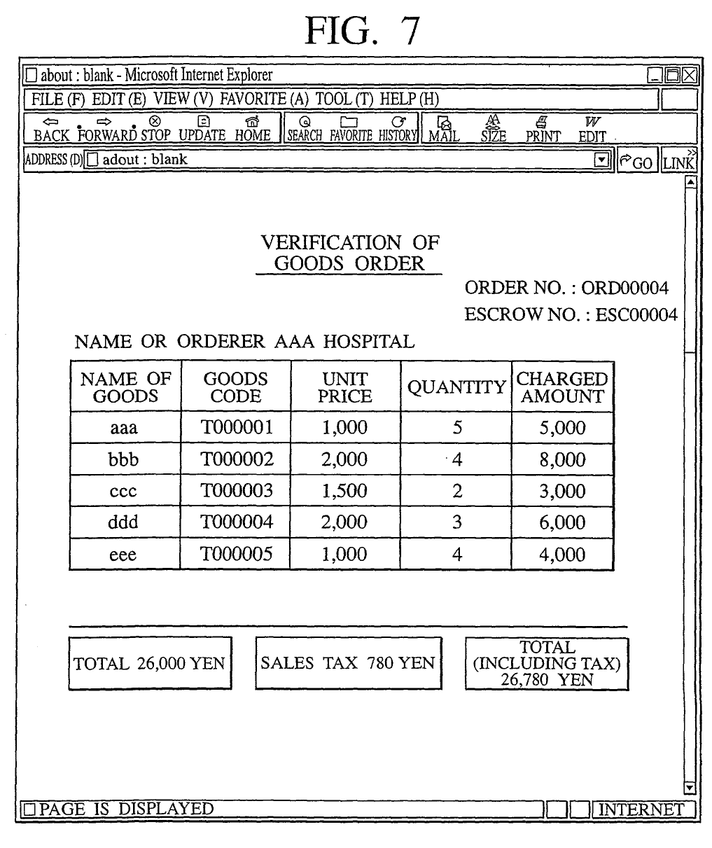

In this case, the buyer can verify ordered goods on a screen as shown in FIG. 7 by accessing the escrow transaction apparatus 5 (S510).

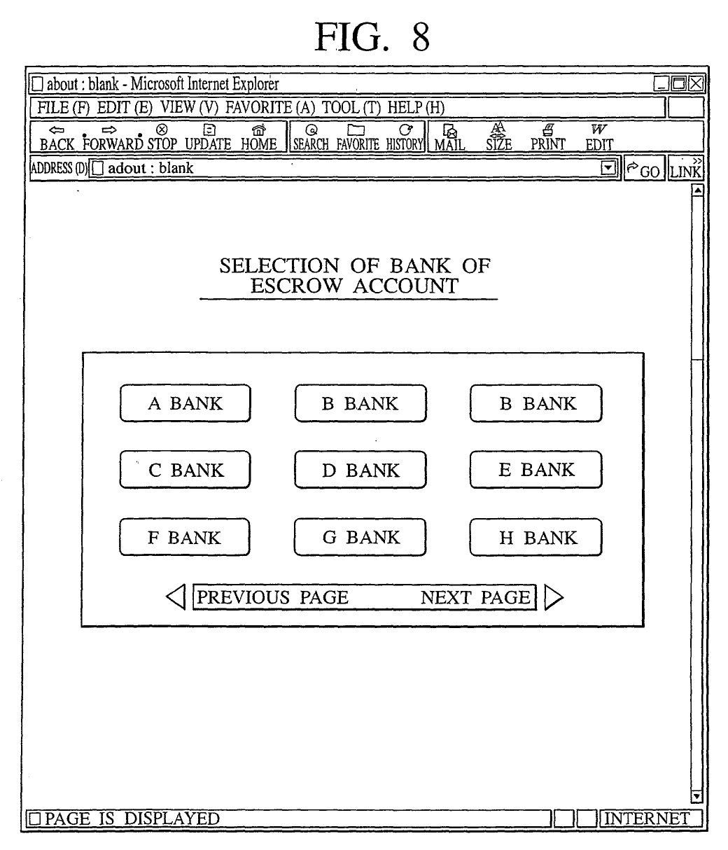

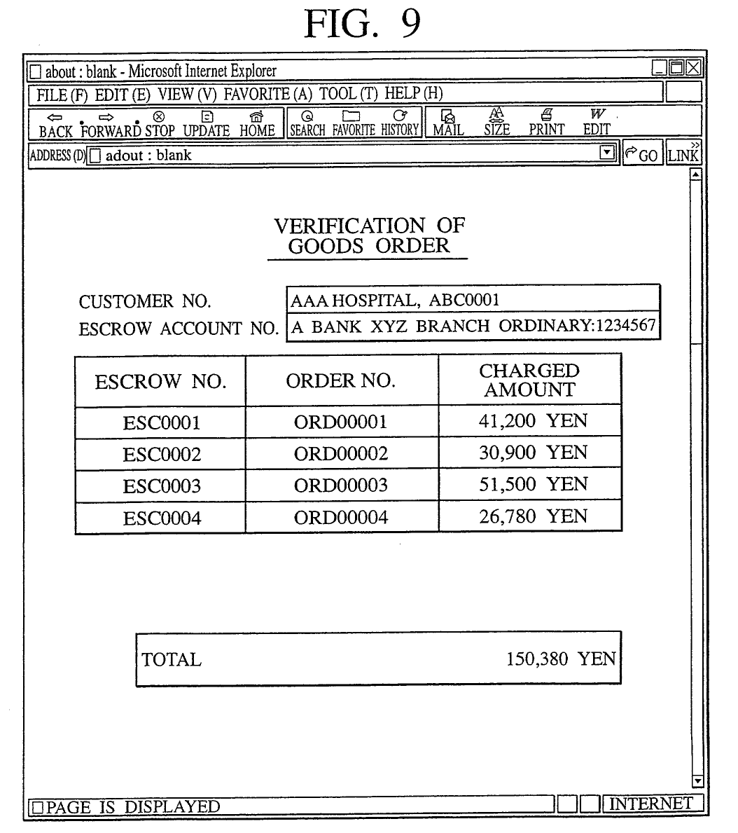

Then, the buyer having selected the escrow transaction selects the escrow bank holding the escrow account on a selection screen as that shown in FIG. 8. Further, the buyer specifies the escrow account on a specification screen shown in FIG. 9, and then transmits it to the escrow transaction apparatus 5 (S511). Upon receipt of this, the escrow transaction commission apparatus 5 registers the escrow account (S512).

After the registration of the escrow account, the buyer enters an instruction to send the escrow costs (S513). Upon having received this money-sending instruction, the escrow transaction commission apparatus 5 instructs the buyer-specified financial institution 11 specified beforehand by the buyer to send money to the escrow financial institution 6 (S514). Upon having received the money-sending instruction, the buyer-specified financial institution 11 sends the escrow costs from an account of the buyer to the escrow account of the escrow bank (S515).

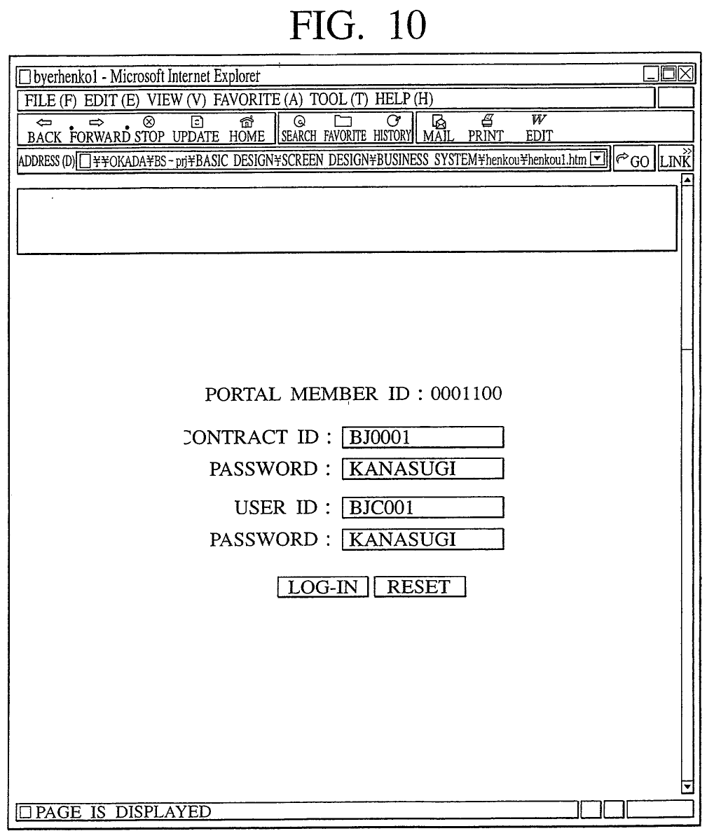

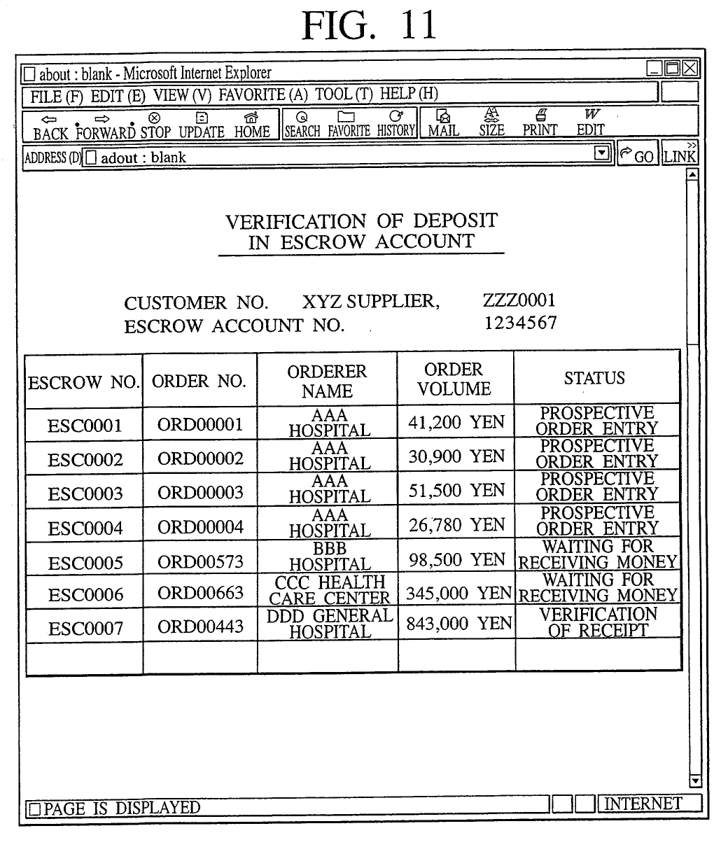

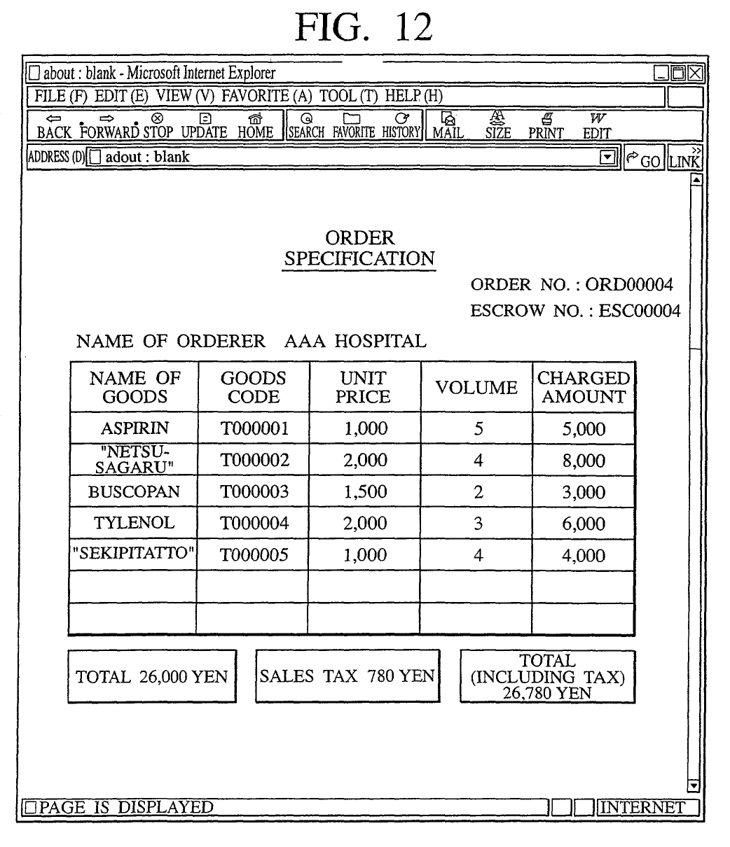

In this case, the supplier can verify a schedule of a deposit in the escrow account or a state of receipt of money on a verification screen as shown in FIG. 11 by entering the contract ID and the user ID on a log-in screen as that shown in FIG. 10 from the supplier terminal 4, and accessing the homepage for suppliers (S516). In addition, by clicking on an escrow number or an order number on the verification screen of FIG. 11, an order specification as that shown in FIG. 12 can be displayed. FIG. 12 shows the order specification displayed when an escrow number “ESC00004” is clicked on the verification screen of FIG. 11.

After the receipt of the escrow costs to the escrow account, the escrow bank 6 transmits a verification of receipt of money to the escrow transaction commission apparatus 5 (S517). Upon receipt of this, the escrow transaction commission apparatus 5 transmits the verification of receipt of money to the supplier (S518).

Upon receiving the verification of receipt, the supplier verifies an orderer, goods, and a quantity on the verification screen (S519), and delivers the ordered goods to the buyer (S520). The buyer having received the goods verifies the contents of the delivered goods (S521), and transmits delivery-verification to the escrow transaction commission apparatus 5 (S522).

Upon receiving the delivery-verification, the escrow transaction commission apparatus 5 transmits an instruction to pay the escrow costs deposited in the escrow account to the escrow bank 6 (S523). According to this payment-instruction, the escrow bank 6 sends the escrow costs to the supplier-specified financial institution 10 specified beforehand by the supplier (S524).

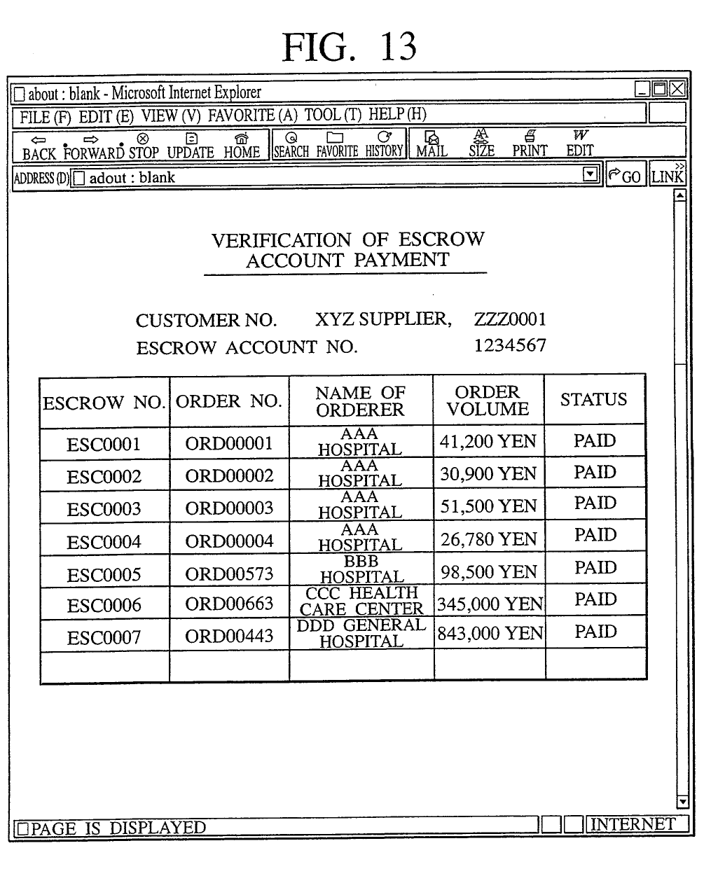

Then, the supplier-specified financial institution 10 having received the escrow costs transmits a notice of payment completion to the escrow transaction commission apparatus 5 and the supplier (S525). The supplier verifies the payment completion on a verification of receipt screen as shown in FIG. 13 (S526), thus finishing the escrow transaction on commission by the escrow transaction commission apparatus 5.

As described above, the escrow transaction commission system 1 of the embodiment can specify an escrow back among a number of financial institutions. Thus, the buyer can make an escrow transaction request to a desired financial institution such as the bank of his account.

(Second Embodiment)

Hereinafter, description will be made of an escrow transaction commission system according to a second embodiment of the present invention with reference to the accompanying drawings. Components similar to those of the first embodiment shown in FIG. 1 are denoted by similar reference numerals, and detailed description thereof is omitted.

1. System Configuration

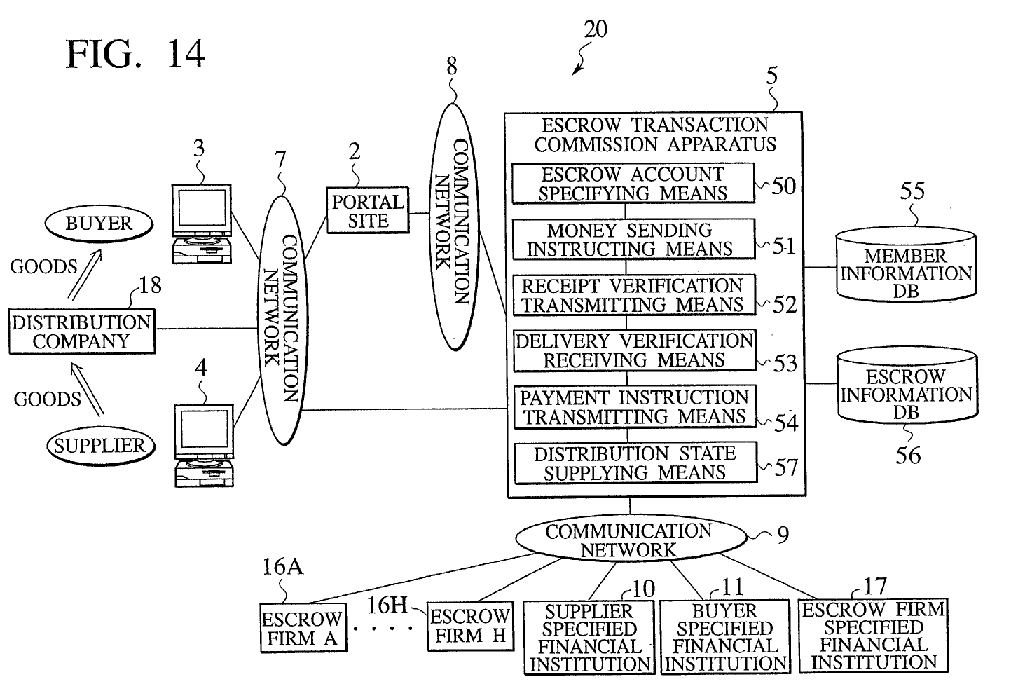

As shown in FIG. 14, an escrow transaction commission system 20 of the present embodiment includes a buyer terminal 3 of a buyer company for buying goods by accessing a portal site 2, a supplier terminal 4 of a supplier company for supplying goods information to the portal site 2, an escrow transaction commission apparatus 5 functioning as a server to execute escrow transactions commission for the transfer of goods and payment for charges generated by transactions between the supplier and the buyer, escrow firms 16A, 16B, . . . , and 16H engaged in escrow business, an escrow firm specified financial institution 17 having an escrow account for depositing escrow costs, a supplier-specified financial institution 10 specified beforehand by the supplier, a buyer-specified financial institution 11 specified beforehand by the buyer, and a distribution company 18 for distributing goods targeted for escrow transactions from the supplier to the buyer. The buyer terminal 3, the supplier terminal 4, the portal site 2, the distribution company 18 and the escrow transaction commission apparatus 5 are interconnected by a communication network 7. The portal site 2, and the escrow transaction commission apparatus 5 are interconnected by a communication network 8. The escrow transaction commission apparatus 5 and the financial institutions 16A, . . . , 16H, 10, 11 and 17 are interconnected by a communication network 9.

Further, the escrow transaction commission apparatus 5 includes escrow account specifying means 50 for allowing the buyer to specify an escrow account for depositing escrow costs generated by a transaction between the buyer and the supplier, money-sending instructing means 51 for instructing the buyer-specified financial institution 11 to send the escrow costs to the escrow account when the buyer enters an instruction to send money to the escrow account; a verification of receipt transmitting means 52 for receiving a verification of receipt of money from the escrow firm specified financial institution 17 when the escrow costs are instructed to be sent is deposited in the escrow account, and transmitting this verification of receipt to the supplier; a delivery-verification receiving means 53 for receiving delivery-verification for verifying the delivery of escrow target goods from the buyer when the supplier delivers the escrow target goods to the buyer based on the verification of receipt, payment-instruction transmitting means 54 for transmitting a payment-instruction to the escrow firm specified financial institution 17 to pay the escrow costs deposited in the escrow account to the supplier-specified financial institution 10 upon receiving the delivery-verification; and a distribution-state supplying means 57 for receiving distribution-state information regarding a distribution-state from the distribution company for distributing escrow target goods, and supplying this distribution-state information to the buyer and the supplier.

The escrow transaction commission apparatus 5 includes a member information database 55 for storing member information of a buyer or a supplier who becomes a member of the escrow transaction commission system 1, and an escrow information database 56 for storing escrow information necessary for escrow transactions. Especially, the escrow information database 56 stores an upper limit of deposits for each escrow firm, registration of joint deposits, registration of deposit transfer, a dealing method for when the upper limit of deposits is exceeded and the like.

Moreover, the escrow firms 16A, 16B, . . . and 16H perform escrow business using escrow transaction only accounts prepared at financial institutions, and include subsidiaries of banks, venture companies and the like in addition to financial institutions such as banks.

The escrow firm specified financial institution 17 has an escrow account for depositing escrow costs, which is specified beforehand by an escrow firm. When escrow costs are sent from the buyer-specified financial institution 11 and deposited, and the supplier delivers escrow target goods to the buyer, the escrow firm specified financial institution 17 bank pays the escrow costs to the supplier-specified financial institution 10.

2. Operation Explanation

Next, description will be made of processing carried out by the escrow transaction commission system 20 of the second embodiment with reference to the accompanying drawings. However, member information registration is carried out similarly to that of the first embodiment, and thus description thereof will be omitted.

2-1. Escrow Transaction on Commission Process

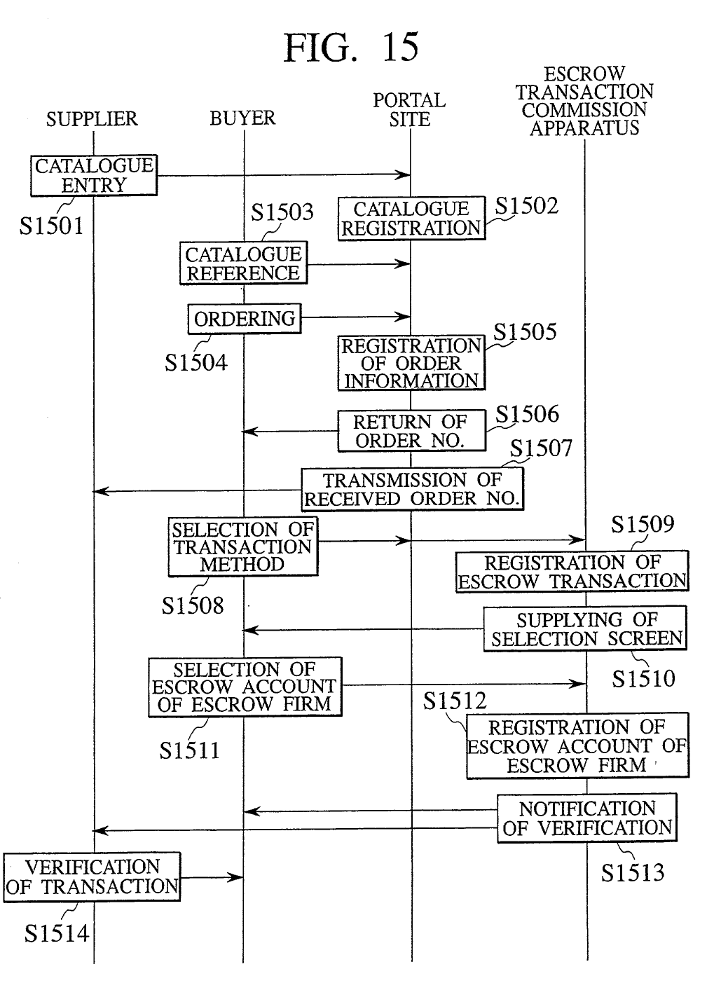

Description is made of escrow transactions on commission process performed through the portal site by the escrow transaction commission apparatus 5 of the embodiment based on a flowchart of FIG. 15.

First, the supplier accesses the portal site 2 from the supplier terminal 4, and inscribes goods to be sold in a catalogue of the portal site 2 (S1501). Upon receipt of this, the portal site 2 registers these goods in the catalogue (S1502).

Then, the buyer accesses the portal site 2 from the buyer terminal 3, and refers to the catalogue (S1503). When there are goods the buyer wants to buy, the buyer sends an order to the portal site 2 (S1504). Upon receipt of the order information, the portal site 2 issues an order number to the buyer and a received order number to the supplier, and then registers the order information (S1505). The portal site 2 returns the issued order number to the buyer (S1506), and transmits the issued received order number to the supplier (S1507).

In this case, the portal site 2 displays a selection screen as shown in FIG. 6 to make the buyer select an escrow transaction or a general transaction. When the buyer selects the escrow transaction, information thereof is transmitted to the portal site 2, and to the escrow transaction commission apparatus 5 (S1508).

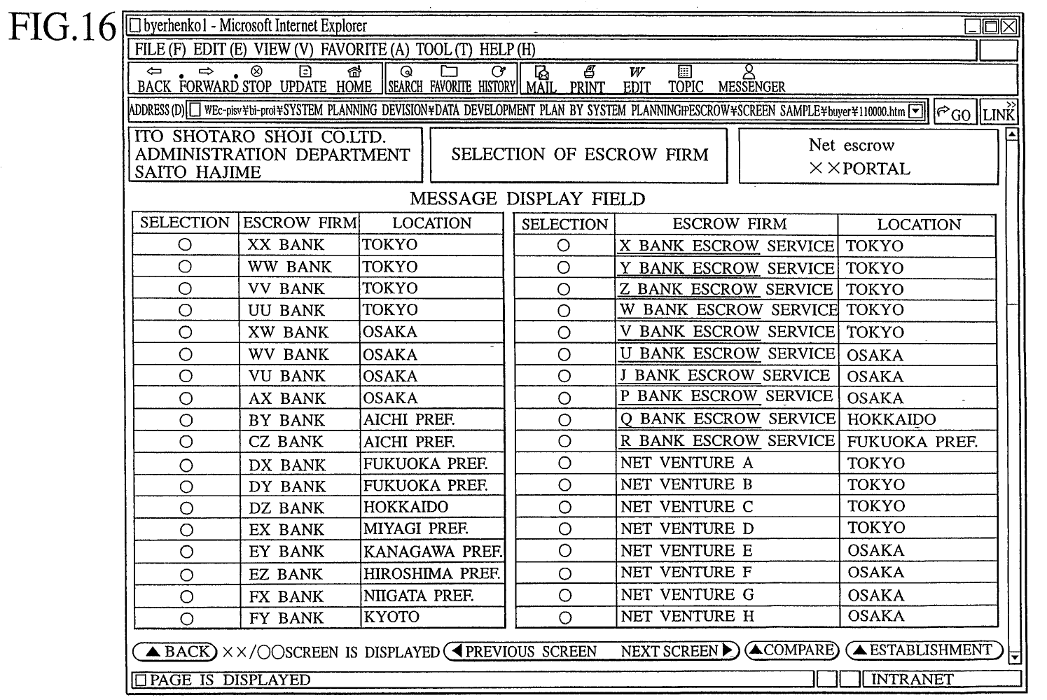

Upon having received the selection of the escrow transaction, the escrow transaction commission apparatus 5 registers the escrow transaction (S1509), and provides an escrow firm selection screen shown in FIG. 16 to the buyer (S1510). As shown in FIG. 16, on the selection screen, not only banks throughout the country but also subsidiaries of banks such as X bank escrow service, and venture companies such as a net venture A can be selected.

Then, the buyer specifies an order number for each transaction on the selection screen, and selects an escrow bank. In this case, the buyer can refer to regions, fees, achievements and the like as information for selecting the escrow firm.

After the specification of the escrow firm, then, an escrow account is specified on a selection screen shown in FIG. 9, and transmitted to the escrow transaction commission apparatus 5 (S1511).

Upon receipt of this, the escrow transaction commission apparatus 5 issues an escrow reception number, correlates the escrow reception number, the order number and the received order number with one another, and registers the escrow firm and the escrow account (S1512).

After the registration of the escrow firm and the escrow account, the escrow transaction commission apparatus 5 transmits a verification notice of the escrow transaction including the escrow reception number to the buyer terminal 3 of the buyer and the supplier terminal 4 of the supplier by electronic mail or the like (S1513). Upon receipt of this, the supplier specifies an escrow reception number, and verifies the escrow transaction to the buyer (S1514). When verification can be made, the registration process of the escrow transaction is finished.

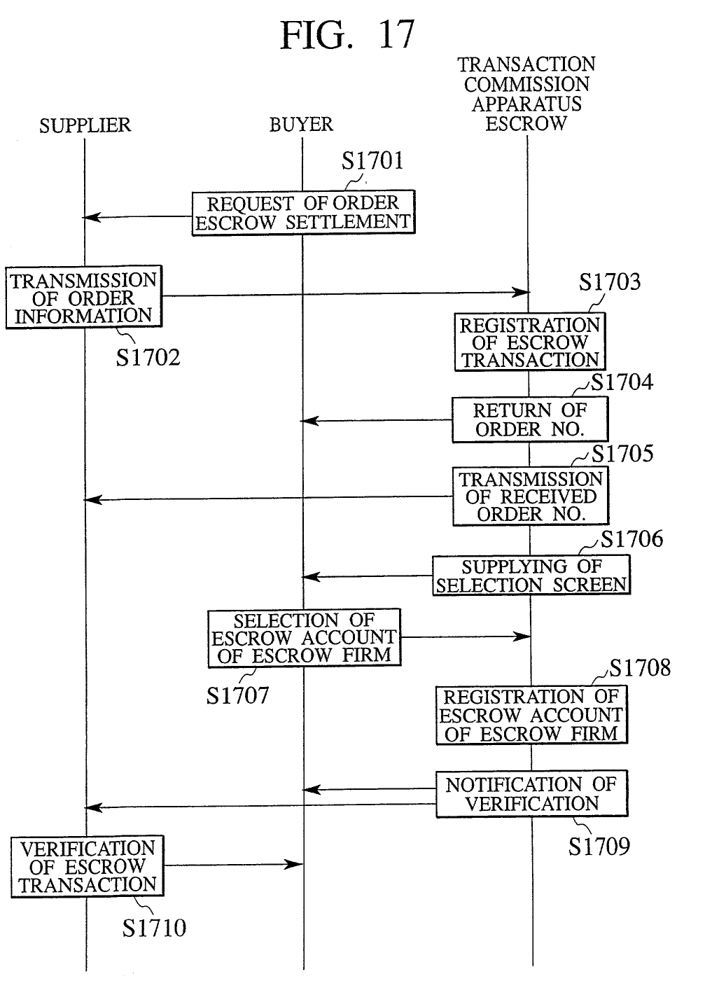

Next, description will be made of the registration process of an escrow transaction made not through the portal site but by the escrow transaction commission apparatus 5 of the embodiment based on a flowchart of FIG. 17.

When the buyer directly transacts with the supplier, not through the portal site 2, first, the buyer directly gives out an order from the buyer terminal 3 to the supplier terminal 4 (S1701). In this case, the buyer requests escrow settlement by the escrow transaction commission apparatus 5 to the supplier.

Then, when the supplier having received the order accepts the escrow settlement by the escrow transaction settlement apparatus 5, the supplier transmits order information to the escrow transaction apparatus 5 (S1702). Upon having received this order information, the escrow transaction commission apparatus 5 issues an order number to the buyer, and a received order number to the buyer, and registers the escrow transaction (S1703). Then, the escrow transaction commission apparatus 5 returns the issued order number to the buyer (S1704), and the issued received order number to the supplier (S1705).

After the registration of the escrow transaction is performed, the escrow firm selection screen shown in FIG. 16 is provided to the buyer (S1706). The buyer specifies an order number for each transaction on the selection screen, selects an escrow firm, and specifies an escrow account on the specification screen shown in FIG. 9, and then transmits it to the escrow transaction commission apparatus 5 (S1707).

Upon receipt of this, the escrow transaction commission apparatus 5 issues an escrow reception number, and correlates the escrow reception number, the order number and the received order number with one another, and registers the escrow firm and the escrow account (S1708).

After the registration of the escrow firm and the escrow account is performed, the escrow transaction commission apparatus 5 transmits a verification notice of the escrow transaction including the escrow reception number to the buyer terminal 3 of the buyer and the supplier terminal 4 of the supplier by electronic mail or the like (S1709). Upon receipt of this, the supplier specifies an escrow reception number, and verifies the escrow transaction to the buyer (S1010). When verified, the registration of the escrow transaction is finished.

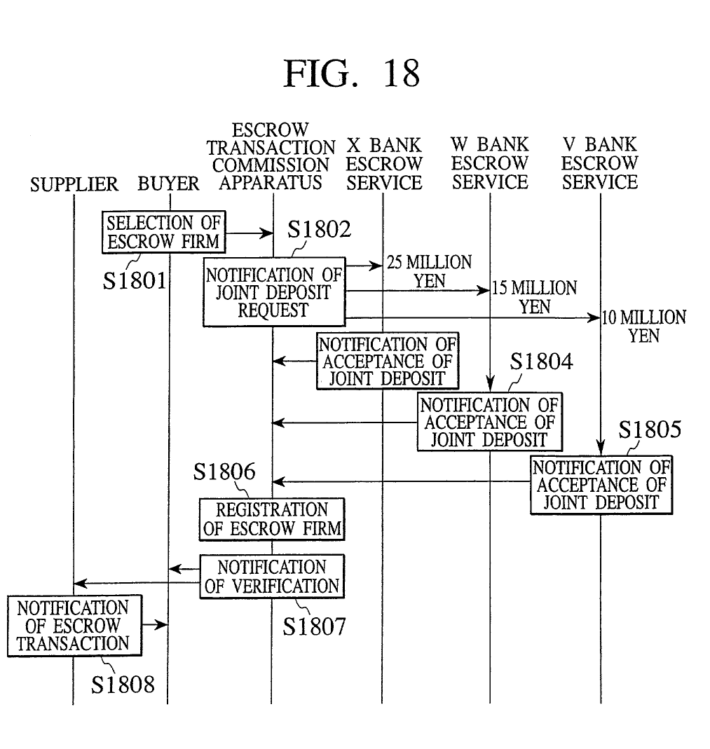

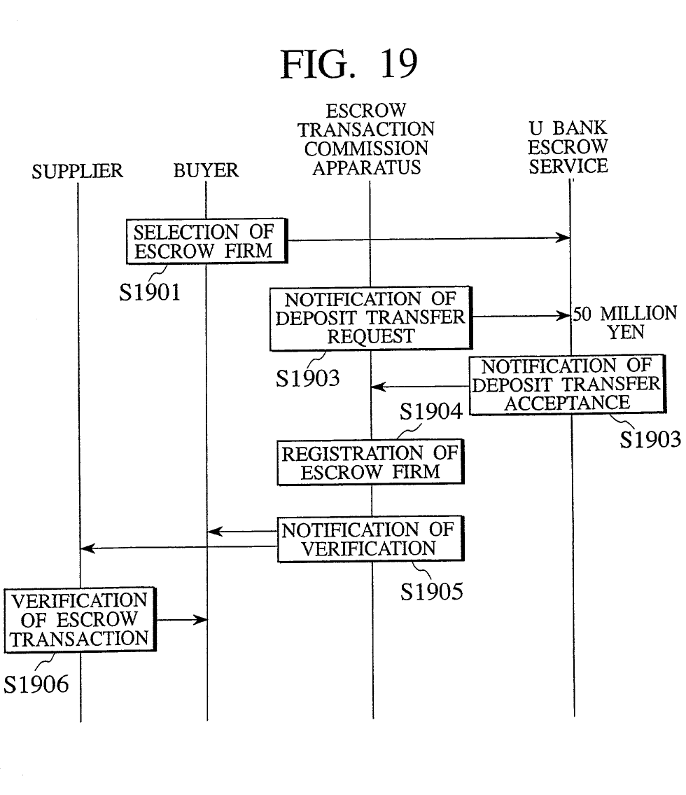

Next, description will be made for processing when the escrow firm is selected in the above-described steps S1511 of FIG. 15 and S1707 of FIG. 17, and the buyer makes a deposit request exceeding an upper limit of deposit of the escrow firm based on flowcharts of FIGS. 18 and 19.

First, based on the flowchart of FIG. 18, description will be made for processing when a deposit is received in a cooperation by a plurality of escrow firms.

When the buyer selects an escrow firm on the escrow firm selection screen shown in FIG. 16, and enters a deposit request amount (S1801), the escrow transaction commission apparatus 5 searches in the escrow information database 56, then determines whether the deposit request amount exceeds the upper limit of request of the requested escrow firm or not. If the upper limit of deposits is exceeded, the escrow transaction commission apparatus 5 transmits a notice of a joint deposit request to the escrow firms (S1802). In this case, the notice of the joint deposit request may be transmitted to all the escrow firms 16A, 16B, . . . , and 16H. Alternatively, escrow firms prepared to accept joint deposit may be registered beforehand, and the notice of the joint deposit request may be transmitted only to the registered escrow firms.

For example, in FIG. 18, the buyer requests an X bank escrow service for an escrow transaction of goods of 50 million yen. However, since an upper limit of deposit of the X bank escrow service is 25 million yen, the escrow transaction commission apparatus 5 transmits the notice of the joint deposit request to a W bank escrow service and a V bank escrow service registered beforehand for joint deposit in addition to the X bank escrow service requested for deposit.

Upon receipt of this, the X bank escrow service returns a notice of joint deposit acceptance indicating that joint deposit of the upper limit 25 million yen (S1803). The W bank escrow service returns a notice of joint deposit acceptance according to a joint of deposit of 15 million yen (S1804). The V bank escrow service also returns a notice of joint deposit acceptance according to a joint deposit of 10 million yen (S1805).

After the specification of a plurality of escrow firms, the escrow transaction commission apparatus 5 issues an escrow reception number, correlates the escrow reception number, the order number and the received order number with one another, and registers the escrow firm and escrow account (S1806).

After the registration of the escrow firm and the escrow account, the escrow transaction commission apparatus 5 transmits a verification notice of the escrow transaction including the escrow reception number to the buyer terminal 3 of the buyer and the supplier terminal 4 of the supplier by electronic mail or the like (S1807). Upon receipt of this, the supplier specifies an escrow reception number, and verifies the escrow transaction to the buyer (S1808). When verified, the registration of the escrow transaction is finished.

Thus, by carrying out joint deposit with the plurality of escrow firms, it is possible to process an escrow transaction, which has been unable to be processed because a limit amount is exceeded to a single escrow firm.

Next, description will be made of processing when a deposit amount is transferred from a small escrow firm to a large escrow firm based on the flowchart of FIG. 19.

When the buyer selects an escrow firm on the escrow firm selection screen shown in FIG. 16, and enters a deposit request amount (S1901), the escrow transaction commission apparatus 5 searches the escrow information database 56, and determines whether the deposit request amount exceeds the upper limit of deposits to the requested escrow firm or not. If the upper limit of deposits is exceeded, the escrow transaction commission apparatus 5 transmits a notice of a deposit transfer request to the escrow firm (S1902). In this case, the notice of the deposit transfer request may be transmitted to all the escrow firms 16A, 16B, . . . , and 16H. Alternatively, escrow firms prepared to accept deposit transfers may be registered beforehand, and the notice of the deposit transfer request may be transmitted only to the registered escrow firms.

For example, in FIG. 19, the buyer requests a nets venture A, which is a small venture company for an escrow transaction of goods of 50 million yen. However, since an upper limit of deposits of the net venture A is 10 million yen, the escrow transaction commission apparatus 5 transmits the notice of the deposit transfer request to a U bank escrow service, which is a large escrow firm capable of accepting a deposit exceeding 50 million yen.

Upon receipt of this, the U bank escrow service returns a notice of acceptance of a deposit of 50 million yen (S1903).

After the specification of the escrow firm to be transferred, the escrow transaction commission apparatus 5 issues an escrow reception number, and correlates the escrow reception number, the order number and the received order number with one another, and registers the escrow firm and escrow account (S1904).

After the registration of the escrow firm and the escrow account, the escrow transaction commission apparatus 5 transmits a verification notice of the escrow transaction including the escrow reception number to the buyer terminal 3 of the buyer and the supplier terminal 4 of the supplier by electronic mail or the like (S1905). Upon receipt of this, the supplier specifies an escrow reception number, and verifies the escrow transaction to the buyer (S1906). When verified, the registration of the escrow transaction is finished.

Thus, by transferring the deposit to the large escrow firm, it is possible to process the escrow transaction which has been unable to be processed because a limit amount was been exceeded to a small escrow firm.

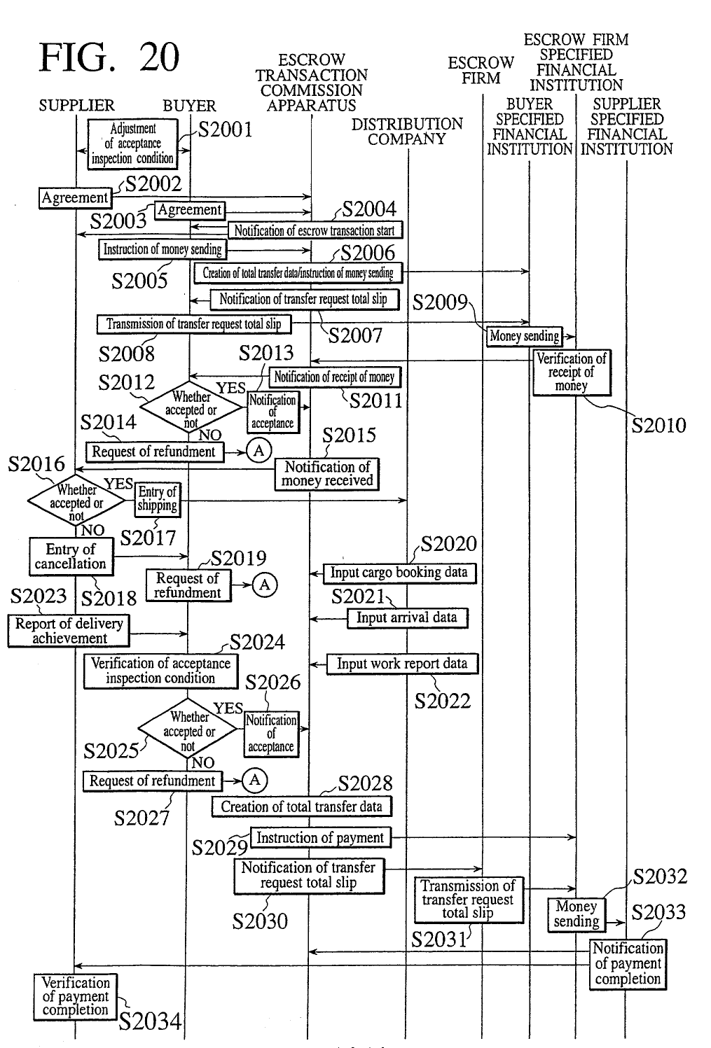

Next, description will be made of the process for escrow transactions commission in by the escrow transaction commission apparatus 5 of the embodiment based on a flowchart of FIG. 20.

After the escrow transaction is registered in the registration process of the escrow transaction shown in FIGS. 15 and 17, acceptance inspection conditions are adjusted between the buyer and the supplier (S2001). In this adjustment of acceptance inspection conditions, the buyer and the supplier respectively enter acceptance inspection conditions such as a delivery place, a delivery place name, a delivery period (from, to), place subject to acceptance inspection, place subject to acceptance inspection name, scheduled acceptance inspection date, a method of delivery (delivery by bringing-in, delivery by installing or the like), a method of acceptance inspection (en bloc, divided, or the like), and years of guarantee (period of damage coverage responsibility), and then the conditions are adjusted therebetween and decided.

Then, when the buyer and the supplier both enter agreements with the acceptance inspection conditions (S2002, and S2003), the escrow transaction commission apparatus 5 issues an escrow transaction number, and transmits a notice of escrow transaction start including the escrow transaction number and an escrow reception number to the buyer and the supplier by electronic mail or the like (S2004).

The buyer having received the notice of the transaction start decides a deposit of money for buying goods, and enters an instruction to send escrow costs (S2005). In this case, the buyer simultaneously transfers deposit fees.

Then, upon having received the money sending instruction, the escrow transaction commission apparatus 5 creates general transfer data, and instructs the buyer-specified financial institution 11 specified beforehand by the buyer to send money to the escrow firm specified financial institution 17 (S2006). Here, the general transfer data contains information such as a sending bank code, a sending store code, a sending deposit type, a sending account number, a transfer number, a sent bank code, a sent store code, a sent deposit type, a sent account number, a name of a sent receiver, a transfer amount of money, a customer code.

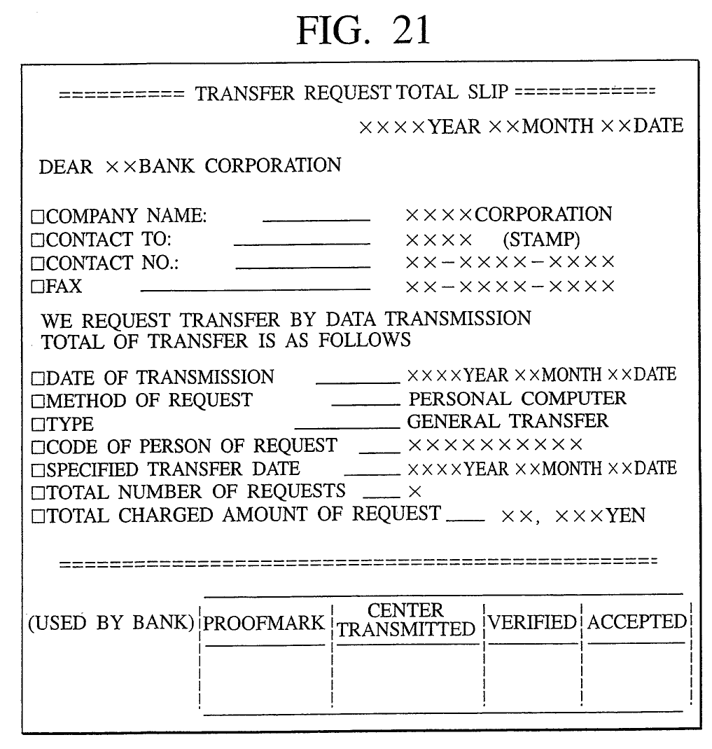

Further, in orders that the buyer verifies the transfer content, the escrow transaction commission apparatus 5 makes a transfer request total slip as that shown in FIG. 21, and notifies this to the buyer by electronic mail or the like (S2007). The buyer having received the transfer request total slip verifies the transfer content, stamps his name on it if correct, and then sends the slip to the buyer-specified financial institution 11 through FAX or the like (S2008).

Upon having received the transfer request total slip and the money sending instruction from the escrow transaction commission apparatus 5, the buyer-specified financial institution 11 sends the escrow cost from the account of the buyer to the escrow account of the escrow firm specified financial institution 17 (S2009).

After the deposit of the escrow costs in the escrow account, the escrow firm specified financial institution 17 transmits a verification of receipt to the escrow transaction commission apparatus 5 (S2010). Upon receipt of this, the escrow transaction commission apparatus 5 transmits a receipt notice of deposited money to the buyer by electronic mail or the like (S2011).

Upon having received the receipt notice, the buyer verifies its content, and determines whether or not to accept it (S2012). If the buyer accepts it, the buyer returns a notice of acceptance to the escrow transaction commission apparatus 5 (S2013). If the buyer does not accept the receipt notice, the buyer transmits a request for a refund to the escrow transaction commission apparatus 5 (S2014), which will be described later.

Upon receiving the acceptance notice from the buyer, the escrow transaction commission apparatus 5 transmits the receipt notice of the deposit money to the supplier by electronic mail or the like (S2015). The supplier having received this receipt notice verifies its content, and determines whether or not to accept it (S2016). If the supplier accepts it, the supplier enters a shipping instruction for instructing the distribution company 18 to ship goods (S2017). In this shipping instruction, for each escrow transaction number, information such as a name of a distribution company name, shipping date, an invoice number, an estimated date of arrival goods and the like are entered, and the invoice number and the escrow transaction number are correlated.

In addition, if the supplier does not accept in step S2016, cancellation is notified to the buyer (S2018). Upon receipt of this, the buyer transmits a request for a refund to the escrow transaction commission apparatus 5 (S2019), which will be described later.

After the entry of the shipping instruction from the supplier to the distribution company 18, the distribution company 18 enters cargo booking data (S2020). This cargo booking data contains information such as an orderer code, order receiver code, a cargo booking number, cargo booking date, an order number, a delivery request number, a cargo booking place name, delivery place name, transfer date, a goods code of an orderer side, a name of goods, volume of order, (volume of delivery request), a volume of cargo booking.

After the delivery of goods to the buyer by the distribution company 18, the distribution company 18 enters arrival data (S2021). This arrival data contains information such as an orderer code, an order receiver code, an arrival number, an arrival date, an order number, a delivery request number, a cargo booking place name, a delivery place name, a transfer date, an orderer side goods name, goods name specification, an order volume, (volume of requested delivery), an arrival volume and a unit.

Further, installation work or the like is carried out after the delivery of the goods to the buyer. When the work is completed, the distribution company 18 enters work report data (S2022). This work report data records whether the respective acceptance inspection conditions have been satisfied or not.

Then, the cargo booking data, the arrival data and the work report data are taken in by the escrow transaction commission apparatus 5, and supplied to the buyer and the supplier through the homepages or the like.

As described above, since the information regarding a distribution state of the goods such as the cargo booking data and the arrival data is supplied by the escrow transaction commission apparatus 5, the buyer and the supplier can verify the distribution state of the goods by accessing the escrow transaction commission apparatus 5 from the buyer terminal 3 or the supplier terminal 4.

After the completion of the delivery of the goods, the supplier reports an achievement of the delivery work with respect to the acceptance inspection conditions to the buyer (S2023). The buyer verifies the acceptance inspection conditions of the delivered goods (S2024).

Then, the buyer verifies the acceptance inspection conditions, and determines whether or not to accept the conditions (S2025). If the buyer accepts the conditions, the buyer transmits a notice of acceptance to the escrow transaction commission apparatus 5 (S2026). If the buyer does not accept the acceptance inspection conditions, the buyer transmits a request for a refund to the escrow transaction commission apparatus 5 (S2027), which will be described later.

Then, the escrow transaction commission apparatus 5 having received the notice of acceptance from the buyer generates general transfer data to be transmitted to the escrow firm specified financial institution 17 (S2028), specified an escrow transaction number, and transmits a payment-instruction to the escrow firm specified financial institution 17 (S2029).

Also, the escrow transmission commission apparatus 5 produces a total transfer request slip for allowing the escrow firm to verify transfer content, and notifies this to the escrow firm by electronic mail or the like (S2030). Upon having received this total transfer request slip, the escrow firm verifies the transfer content, stamps its name if correct, and sends it to the escrow firm specified financial institution 17 through FAX or the like (S2031).

Upon having received the total transfer request slip, the escrow firm specified financial institution 17 sends money to the supplier-specified financial institution 10 specified beforehand by the supplier (S2032).

Then, the escrow transaction commission apparatus 5 transmits a notice of payment completion based on a result of money sending of the escrow firm specified financial institution 17 (S2033). The supplier verifies the completion of payment on a verification of receipt screen as that shown in FIG. 13 (S2034), and the escrow transaction on commission by the escrow transaction commission apparatus 5 is finished.

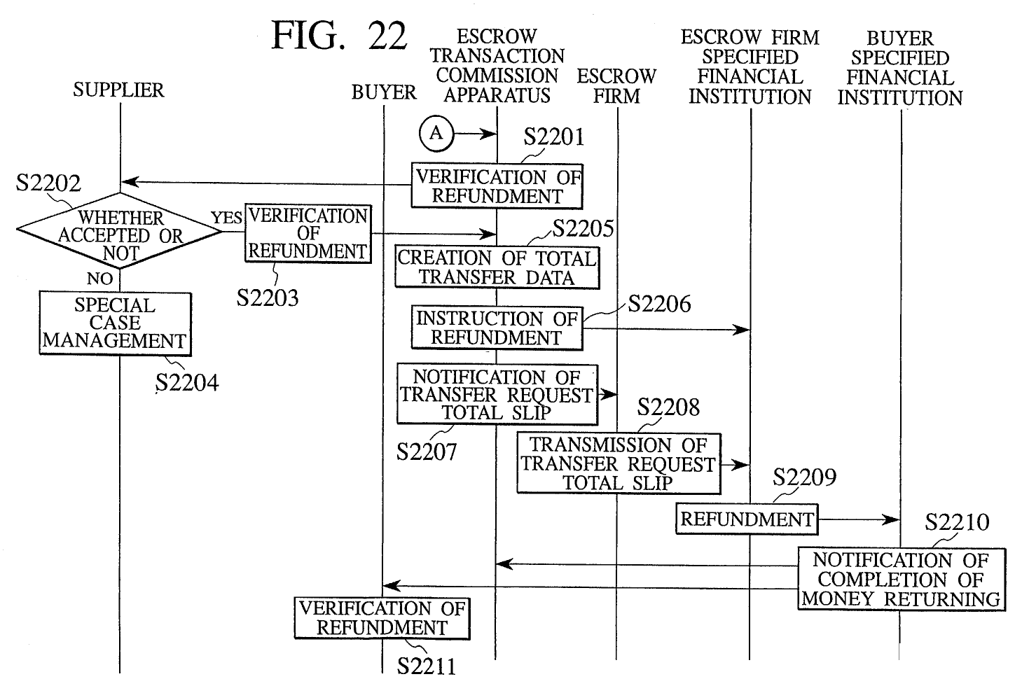

Next, based on a flowchart of FIG. 22, description will be made for an escrow transaction on commission when the request of refund is entered in steps S2014, S2019 and S2027 of FIG. 20.

In the refund request of steps S2014, S2019 and S2027 of FIG. 20, the buyer specifies an escrow transaction number, and makes a refund request to the escrow transaction commission apparatus 5.

Upon receipt of this, the escrow transaction commission apparatus 5 notifies the supplier to verify the refund by electronic mail or the like (S2201).

After the verification or the like of the return of goods, the supplier determines whether or not to accept the refund (S2202). If the supplier accepts the refund, the supplier transmits a notice of acceptance of the refund to the escrow transaction commission apparatus 5 (S2203). Here, if the supplier does not accept the refund for a long time, then the process is cut off from the escrow transaction commission system 20, and transferred to special management (S2204).

Then, upon having received the notice of the refund acceptance, the escrow transaction commission apparatus 5 produces general transfer data to transmit to the escrow firm specified financial institution (S2205), specifies an escrow transaction number, and then transmits a refund instruction to the escrow firm specified financial institution 17 (S2206).

Further, the escrow transaction commission apparatus 5 produces a total transfer request slip to allow the escrow firm to verify refund content, and notifies it to the escrow firm by electronic mail or the like (S2207). Upon having received the total transfer request slip, the escrow firm verifies the transfer content, stamps his name on it if correct, and then sends it to the escrow firm specified financial institution 17 (S2208).

Upon having received the total transfer request slip, and the escrow firm specified financial institution 17 refunds the escrow costs to the buyer-specified financial institution 10 (S2209).

Then, the buyer-specified financial institution 10 having received the refund of the escrow costs transmits a notice of refund completion to the escrow transaction commission apparatus 5 and the buyer (S2210). The buyer verifies the completion of the refund (S2211), and the escrow transaction on commission process by the escrow transaction commission apparatus 5 is finished.

As described above, since the escrow transaction commission system 1 of the embodiment enables the buyer to specify an escrow firm among a number of financial institutions. Thus, the buyer can make an escrow transaction request to a desired financial institution such as the bank of his account.

Furthermore, programs for achieving the processing operations of the escrow transaction commission apparatus 5 in the foregoing escrow transaction commission system can be saved in a recording medium. By allowing a computer system to read from the recording-medium, the processing operations of the escrow transaction commission apparatus 5 can be achieved by executing the programs and controlling the computer. In this case, the recording-medium includes a device capable of recording the programs, e.g., a memory, a magnet disk device, an optical disk device or the like.

As obvious from appended claims, such inventions are also within the technical scope of the present invention.

Industrial Applicability

As described above, according to the escrow transaction commission system of the present invention, since the buyer can specify an escrow firm from among a number of financial institutions, it is possible to perform escrow transaction commission for the escrow firm desired by the buyer.

What is claimed is:

1. An escrow transaction commission method, in which transactions are carried out between a supplier for supplying goods and a buyer for buying the goods through a portal site using a computer system, and an escrow transaction commission of processing the transfer of goods and payment of costs generated by the transaction is executed by a server,
wherein said buyer specifies an escrow account for depositing escrow cost generated by the transaction on said portal site, said server allows a buyer specified financial institution specified by said buyer to send said escrow costs to an escrow bank holding said escrow account when said buyer enters an instruction for sending said escrow costs to said escrow account,
when the deposit of said escrow costs in said escrow account is performed, said server receives a verification of the receipt of money from said escrow bank and then transmits the verification of receipt of money to said supplier, and
when said supplier having received the verification of receipt of money delivers escrow target goods to said buyer, said server allows said escrow bank to pay said escrow cost deposited in said escrow account into a supplier specified financial institution specified by said supplier.

2. An escrow transaction commission apparatus for carrying out transactions between a supplier for supplying goods and a buyer for buying the goods through a portal site by a computer system, and for executing an escrow transaction commission of processing the transfer of goods and payment of costs generated by the transaction by a server, the apparatus comprising:
an escrow account specifying means for allowing said buyer to specify an escrow account for depositing escrow costs generated by the transaction on said portal site,
a money-sending instructing means for instructing a buyer-specified financial institution specified by said buyer to send said escrow costs to an escrow bank having said escrow account when said buyer enters an instruction for sending money to said escrow account specified by said escrow account specifying means,
a receipt-verification transmitting means for receiving a verification of receipt of money from said escrow bank when said escrow costs instructed to be sent by the money sending instructing means are deposited in said escrow account, and then transmitting this verification of receipt of money to said supplier,
a delivery-verification receiving means for receiving a delivery verification for verifying the delivery of escrow target goods from said buyer when said supplier delivers said escrow target goods to said buyer based on the verification of receipt of money transmitted from the verification of receipt transmitting means, and
payment-instruction transmitting means for transmitting a payment instruction to said escrow bank to pay said escrow costs deposited in said escrow account to a supplier-specified financial institution specified by said supplier when the delivery-verification is received by the delivery-verification receiving means.

3. A recording-medium for recording an escrow transaction commission program for carrying out transactions between a supplier for supplying goods and a buyer for buying the goods through a portal site by a computer system, and for executing an escrow transaction commission of processing the transfer of goods and payment of costs generated by the transaction on said portal site, the recording-medium comprising:
an escrow account specification process for allowing said buyer to specify an escrow account for depositing escrow costs generated by the transaction;
a money-sending instruction for instructing a buyer-specified financial institution specified by said buyer to send said escrow costs to an escrow bank having said escrow account when said buyer enters an instruction for sending money to said escrow account specified by said escrow account specification;
a receipt-verification transmission process for receiving a verification of receipt of money from said escrow bank when said escrow costs instructed to be sent by the money sending instruction are deposited in said escrow account, and then transmitting this verification of receipt to said supplier;
a delivery-verification reception process for receiving a delivery verification for verifying the delivery of escrow target goods from said buyer when said supplier delivers said escrow target goods to said buyer based on the verification of receipt transmitted in the receipt-verification transmission; and
a payment-instruction transmission process for transmitting a payment instruction to said escrow bank to pay said escrow costs deposited in said escrow account to a supplier-specified financial institution specified by said supplier when the delivery-verification is received through the delivery-verification reception.

4. A buyer terminal of a buyer for buying goods by carrying out transactions with a supplier for supplying goods, and for executing an escrow transaction through a server using a computer system,
wherein said buyer is prompted to specify an escrow account for depositing escrow costs generated by the transaction with said supplier, and the specified escrow account is transmitted to the server,
said buyer is prompted to enter an instruction for sending said escrow costs to said escrow account, and the entered money sending instruction is transmitted to the server,
said supplier delivers escrow target goods to said buyer and when said buyer enters a delivery-verification for verifying delivery of said escrow target goods, this delivery-verification is transmitted to the server.

5. A supplier terminal of a supplier for carrying out transactions with a buyer to sell goods, and for executing an escrow transaction through a server by a computer system, wherein
when escrow costs generated by the transaction with said buyer are received in an escrow account for depositing said escrow costs, a verification of receipt of money transmitted from an escrow bank having said escrow account is received through the server and,
when said escrow costs are sent to a supplier-specified financial institution specified by said supplier, a notice of payment completion is received from said supplier-specified financial institution.

6. A escrow transaction commission method, in which transactions are carried out between a supplier for supplying goods and a buyer for buying the goods, and an escrow transaction commission of processing the transfer of goods and payment of costs generated by the transaction is executed through a server using a computer system,
wherein said buyer specifies an escrow account for depositing escrow costs generated by the transaction between said buyer and said supplier, the server allows a buyer-specified financial institution specified by said buyer to send said escrow costs to said escrow account when said buyer enters an instruction for sending said escrow costs to said escrow account,
when the deposit of said escrow costs to said escrow account is performed, the server receives a verification of receipt of money from an escrow firm specified financial institution having said escrow account and then transmits the verification of receipt of money to said supplier, and when said supplier having received the verification of receipt of money delivers escrow target goods to said buyer, the server allows said escrow firm specified financial institution to pay said escrow costs to a supplier-specified financial institution specified by said supplier.

7. An escrow transaction commission apparatus for carrying out transactions between a supplier for supplying goods and a buyer for buying the goods, for executing an escrow transaction commission of processing the transfer of goods and payment of costs generated by the transaction by a computer system, the apparatus comprising:
an escrow account specifying means for allowing said buyer to specify an escrow account for depositing escrow cost generated by the transaction between said buyer and said supplier,
a money-sending instructing means for instructing a buyer specified financial institution specified by said buyer to send said escrow cost to said escrow account when said buyer enters an instruction for sending money to said escrow account specified by said escrow account specifying means;
a receipt-verification transmitting means for receiving a verification of receipt of money from an escrow firm specified financial institution having said escrow account bank when said escrow cost instructed to be sent by the money sending instructing means are deposited in said escrow account, and then transmitting this verification of receipt to said supplier;
a delivery-verification receiving means for receiving delivery verification for verifying the delivery of escrow target goods from said buyer when said supplier delivers said escrow target goods to said buyer based on the verification of receipt of money transmitted by the verification of receipt transmitting means, and
payment-instruction transmitting means for transmitting a payment instruction to said escrow firm specified financial institution to pay said escrow costs deposited in said escrow account to a supplier-specified financial institution specified by said supplier when the delivery-verification is received by the delivery-verification receiving means.

8. Said escrow transaction commission apparatus according to claim 7, wherein when said escrow costs exceed an upper limit of the deposits of said escrow firm for carrying out escrow business using said escrow account, said escrow costs are deposited in a plurality of escrow forms.

9. Said escrow account specifying means according to any one of claims 7 and 8, wherein when said escrow costs exceed an upper limit of the deposits of said escrow firm for carrying out escrow business using said escrow account, a deposit transfer of said escrow costs is made to an escrow firm having an upper limit of deposit equal to/higher than said escrow costs.

10. Said escrow transaction commission apparatus of claims 7, 8, or 9, further comprising a distribution state supplying means for receiving distribution state information regarding a distribution state from a distribution company for distributing said escrow target goods, and supplying the distribution state information to said buyer and said supplier.

11. A recording-medium for recording an escrow transaction commission program for carrying out transactions between a supplier for supplying goods and a buyer for buying the goods, and for executing an escrow transaction commission of processing the transfer of goods and payment of costs generated by the transaction using a computer system, the recording-medium comprising;
an escrow account specification process for allowing said buyer to specify an escrow account for depositing escrow costs generated by the transaction between said buyer and said supplier;
a money-sending instruction for instructing a buyer-specified financial institution specified by said buyer to send said escrow costs to said escrow account when said buyer enters an instruction for sending money to said escrow account specified by said escrow account specification,
a receipt-verification of transmission process for receiving a verification of receipt of money from an escrow firm specified financial institution having said escrow account when said escrow cost instructed to be sent by the money sending instruction are deposited in said escrow account, and then transmitting this verification of receipt of money to said supplier;
a delivery-verification reception process for receiving a delivery verification for verifying the delivery of escrow target goods from said buyer when said supplier delivers said escrow target goods to said buyer based on the verification of receipt of money transmitted by the verification of receipt transmission process; and
a payment-instruction transmission process for transmitting a payment instruction to said escrow firm specified financial institution to pay said escrow costs deposited in said escrow account to a supplier-specified financial institution specified by said supplier when the delivery-verification is received by the delivery-verification reception.

12. A buyer terminal of a buyer for buying goods by carrying out transactions with a supplier for supplying goods, and for executing an escrow transaction through a server using a computer system, wherein
said buyer is prompted to specify an escrow account for depositing escrow costs generated by the transaction with said supplier, the specified escrow account is transmitted to the server,
said buyer is prompted to enter an instruction for sending said escrow costs to said escrow account, the entered money sending instruction is transmitted to the server,
said escrow costs are deposited in said escrow account, a notice of receipt of said escrow costs are received through the server, a notice of acceptance is transmitted to the server when said buyer accepts the notice of the receipt of money,
said supplier delivers escrow target goods to said buyer and when said buyer verifies that preset acceptance inspection conditions have been met for said escrow target goods, and enters delivery-verification, this delivery-verification is transmitted to the server.

13. A supplier terminal of a supplier for carrying out transactions with a buyer to sell goods, and for executing an escrow transaction through a server using a computer system, wherein
when escrow costs generated by the transaction with said buyer are received in an escrow account for depositing said escrow costs, a receipt notice transmitted from an escrow firm specified financial institution holding said escrow account is received through the server,
a shipping instruction for said escrow target goods is transmitted to a distribution company for distributing said escrow target goods when said supplier enters an acceptance of receipt notice and;
when said escrow costs are sent to a supplier-specified financial institution specified by said supplier, a notice of payment completion is received from said supplier-specified financial institution.
